(19) United States
(12) Patent Application Publication
(10) Pub. No.: US 2022/0131275 A1
(43) Pub. Date: Apr. 28, 2022

(54) APPARATUS FOR WAVEGUIDE TRANSITION AND ANTENNA ARRAY HAVING THE SAME

(71) Applicant: MICROELECTRONICS TECHNOLOGY, INC., Hsinchu (TW)

(72) Inventors: Chang-Chun Chen, Hsinchu (TW); Wei Huang Chen, Hsinchu (TW); Tung-Hua Yang, Hsinchu (TW)

(21) Appl. No.: 17/080,251

(22) Filed: Oct. 26, 2020

(51) Int. Cl. H01Q 21/00; H01Q 1/48; H01Q 21/06

(52) U.S. Cl. CPC H01Q 21/0075; H01Q 21/065; H01Q 1/48

(57) ABSTRACT

The present disclosure provides an apparatus for waveguide transmission and an antenna array including the apparatus. The apparatus for waveguide transition includes a dielectric substrate, a transmission line structure, a conductor pattern for shorting a waveguide, and a plurality of vias. The transmission line structure includes a ground conductor pattern separated from a strip conductor pattern by the dielectric substrate, wherein the ground conductor pattern has a ground aperture portion. The waveguide is electrically coupled to the strip conductor pattern. The vias are electrically coupled to the ground conductor pattern and the conductor pattern for shorting the waveguide. The waveguide is connected to the dielectric substrate so as to correspond to the ground aperture portion.

### TECHNICAL FIELD

The present disclosure relates to an apparatus for waveguide transition, and more particularly, to an apparatus for waveguide transition and an antenna array having the same.

### DISCUSSION OF THE BACKGROUND

Communication systems utilizing millimeter waves or microwaves are used in various application fields. For example, such communication systems are used for signal transmission between base stations in mobile communication systems, vehicle anti-collision radar systems, fixed wireless network access systems, and outdoor communication systems. Moreover, the use of such communication systems in various fields requires a high transmission rate. However, since such communication systems are fabricated by assembling separate components, these communication systems often include waveguide transition devices that are both large and expensive. Therefore, it is crucial to develop a waveguide transition device that can be miniaturized and easily fabricated with standard manufacturing processes, and that also provides proper impedance matching and other functions such as power splitting and combining.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides an apparatus for waveguide transition, comprising a dielectric substrate, a transmission line structure, a conductor pattern for shorting a waveguide, and a plurality of vias. The transmission line structure comprises a ground conductor pattern separated from a strip conductor pattern by the dielectric substrate, wherein the ground conductor pattern includes a ground aperture portion. The waveguide is electrically coupled to the strip conductor pattern. The vias are electrically coupled to the ground conductor pattern and the conductor pattern for shorting the waveguide. The waveguide is connected to the dielectric substrate so as to correspond to the ground aperture portion.

In some embodiments, the transmission line structure further comprises a first transmission line-splitting portion and a second transmission line-splitting portion.

In some embodiments, the ground conductor pattern is disposed on a surface of the dielectric substrate, and the strip conductor pattern is disposed on another surface of the dielectric substrate opposite to the surface haying the ground conductor pattern.

In some embodiments, the transmission line structure further comprises one or more quarter-wavelength matching sections.

In some embodiments, the ground aperture portion has a polygonal shape, and a portion of the strip conductor pattern is substantially parallel to one side of the polygonal shape.

In some embodiments, the dielectric substrate is a single-layer dielectric substrate.

In some embodiments, the dielectric substrate is a multilayer dielectric substrate.

In some embodiments, the apparatus further comprises a metal member disposed above the round aperture portion.

In some embodiments, the vias form a plurality of fence via structures.

In some embodiments, the transmission line structure is a microstrip line, a stripline, or a coplanar waveguide.

Another aspect of the present disclosure provides an antenna array, including a plurality of antenna elements spaced apart from each other, and a feed network electrically coupled to the antenna elements for signal distribution. The feed network includes a plurality of apparatuses for waveguide transition. At least one the apparatuses for waveguide transition includes a dielectric substrate, a transmission line structure, a conductor pattern for shorting a waveguide, and a plurality of vias. The transmission line structure includes a ground conductor pattern separated from a strip conductor pattern by the dielectric substrate, wherein the ground conductor pattern has a ground aperture portion. The waveguide is electrically coupled to the strip conductor pattern. The vias are electrically coupled to the ground conductor pattern and the conductor pattern for shorting the waveguide. The waveguide is connected to the dielectric substrate so as to correspond to the ground aperture portion.

In some embodiments, the transmission line structure further comprises a first transmission line-splitting portion and a second transmission line-splitting portion.

In some embodiments, the ground conductor pattern is disposed on a surface of the dielectric substrate, and the strip conductor pattern is disposed on another surface of the dielectric substrate opposite to the surface having the ground conductor pattern.

In some embodiments, the transmission line structure further comprises one or more quarter-wavelength matching sections.

In some embodiments, the ground aperture portion has a polygonal shape, and a portion of the strip conductor pattern is substantially parallel to one side of the polygonal shape.

In some embodiments, the dielectric substrate is a single-layer dielectric substrate.

In some embodiments, the dielectric substrate is a multilayer dielectric substrate.

In some embodiments, at least one the apparatuses for waveguide transition further comprises a metal member disposed above the ground aperture portion.

In some embodiments, the vias form a plurality of fence via structures.

In some embodiments, the transmission line structure is a microstrip line, a stripline, or a coplanar waveguide.

Accordingly, the apparatuses for waveguide transition of the present disclosure enable impedance matching and power distribution in a compact footprint. Compared to the feed network of the comparative antenna array, the apparatuses for waveguide transition in the feed network of the antenna array in the present disclosure include impedance-matching and power-dividing/combining functions within a compact area without sacrificing performance or complicating fabrication. Therefore, the apparatuses for waveguide transition of the present disclosure can be readily miniaturized and integrated with other electronic systems.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a perspective view of an apparatus for waveguide transition according to some embodiments of the present disclosure;

FIG. 2 is a top view of an apparatus for waveguide transition according to some embodiments of the present disclosure;

FIG. 3 is a cross-sectional view of an apparatus for waveguide transition along a line A-A′ of FIG. 2 according to some embodiments of the present disclosure;

FIG. 4 is a cross-sectional view of an apparatus for waveguide transition along a line B-B′ of FIG. 3 according to some embodiments of the present disclosure;

FIG. 5 is a cross-sectional view of an apparatus for waveguide transition according to some embodiments of the present disclosure;

FIG. 6 is a perspective view of an antenna array according to some embodiments of the present disclosure;

FIG. 7 is a close-up top view of a section C of the antenna array shown in FIG. 6;

FIG. 8 is a perspective view of an antenna array according to a comparative embodiment of the present disclosure; and

FIG. 9 is a close-up top view of a section D of the antenna array show in FIG. 8.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

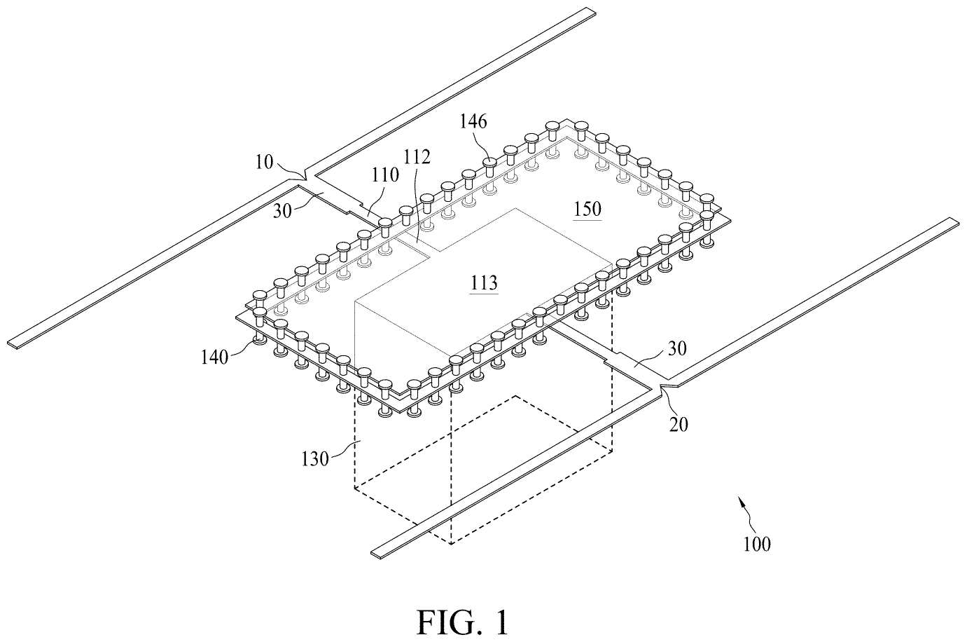

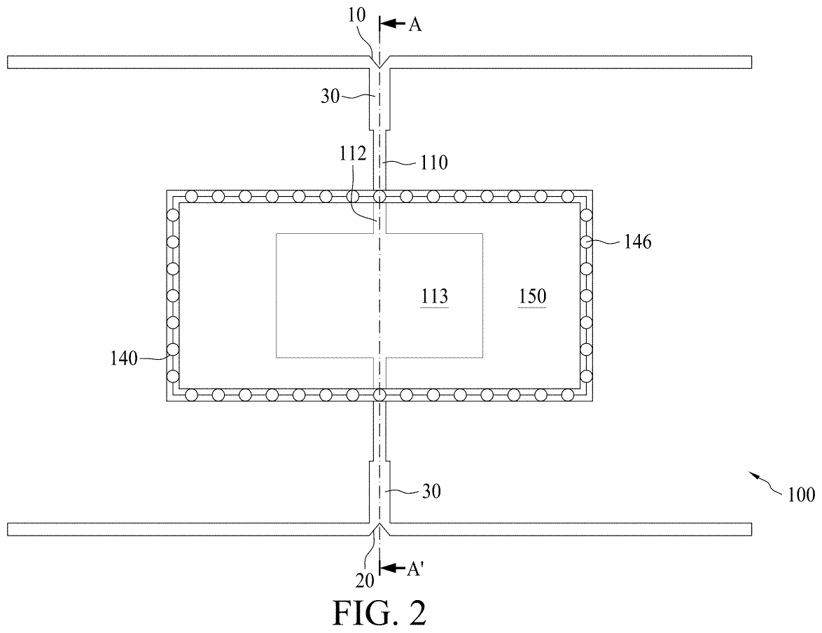

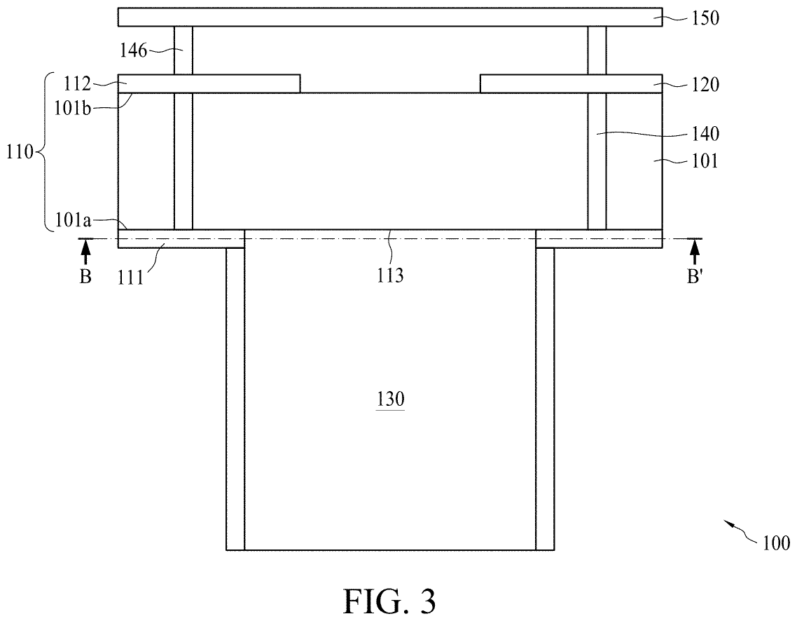

FIG. 1 is a perspective view of an apparatus 100 for waveguide transition according to some embodiments of the present disclosure. FIG. 2 is a top view of the apparatus 100 for waveguide transition according to some embodiments of the present disclosure. FIG. 3 is a cross-sectional view of the apparatus 100 for waveguide transition along a line A-A′ of FIG. 2 according to some embodiments of the present disclosure. With reference to FIG. 1 to FIG. 3, the apparatus 100 for waveguide transition includes a dielectric substrate 101, a transmission line structure 110, a conductor pattern 120 for shorting a waveguide 130, and a plurality of vias 140. The transmission line structure 110 includes a ground conductor pattern 111 separated from a strip conductor pattern 112 by the dielectric substrate 101, wherein the ground conductor pattern 111 has a ground aperture portion 113. In some embodiments, the waveguide 130 is electrically coupled to the strip conductor pattern 112. The vias 140 are electrically coupled to the ground conductor pattern 111 and the conductor pattern 120 for shorting the waveguide 130. In some embodiments, the waveguide 130 is connected to the dielectric substrate 101 so as to correspond to the ground aperture portion 113. In some embodiments, the ground conductor pattern 111 is disposed on a surface 101a of the dielectric substrate 101, and the strip conductor pattern 112 is disposed on another surface 101b of the dielectric substrate 101 opposite to the surface 101a having the ground conductor pattern 111.

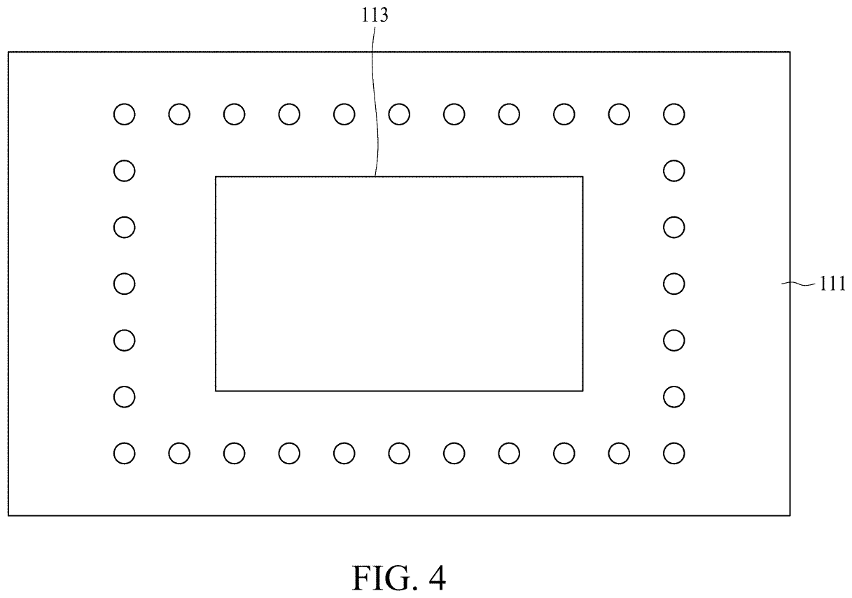

FIG. 4 is a cross-sectional view of the apparatus 100 for waveguide transition along a line B-B′ of FIG. 3 according to some embodiments of the present disclosure. With reference to FIG. 3 and FIG. 4, in some embodiments, the ground aperture portion 113 has a polygonal shape such as a rectangle, for example. A portion of the strip conductor pattern 112 may be configured to be substantially parallel to one side of the polygonal shape. It should be noted that, in some embodiments according to the particular application, the ground aperture portion 113 may be configured as another polygonal shape such as a square, a trapezoid, or other suitable shape having symmetrical or asymmetrical sides. In some embodiments, the polygonal shape of the ground aperture portion 113 may have one side less than twice the length of another side.

With reference to FIG. 1 to FIG. 3, in some embodiments, the transmission line structure 110 further includes a first transmission line-splitting portion 10 and a second transmission line-splitting portion 20. The first transmission line-splitting portion 10 and the second transmission line-splitting portion 20 may be configured such that the apparatus 100 for waveguide transition can be used as a power splitter or a power combiner, for example. In some embodiments, the transmission line structure 110 may further include one or more quarter-wavelength matching sections 30 to optimize the impedance matching of a center frequency of the waveguide 130, which may be 24 GHz, 28 GHz, or 60 GHz, for example. It should be noted that the length and other characteristics of the quarter-wavelength matching sections 30 may be adjusted according to the center frequency of the waveguide 130.

In some embodiments, the apparatus 100 for waveguide transition further includes a metal member 150 disposed above the ground aperture portion 113. The metal member 150 may serve as a backshort layer configured and spaced to optimize the impedance matching for the center frequency of the waveguide 130. In some embodiments, the vias 140 form a plurality of fence via structures 146 which may be configured to further optimize the transition of the waveguide 130. In some embodiments, the fence via structures 146 may be configured to have a polygonal shape with one side greater than twice the length of another side. In some embodiments, according, to the particular application, the transmission line structure 110 may be a microstrip line, a stripline, or a coplanar waveguide. In some embodiments, the configurations, spacing, and dimensions of the dielectric substrate 101, the conductor pattern 120, the vias 140, the ground conductor pattern 111, and the strip conductor pattern 112 may also be adjusted according to the center frequency of the waveguide 130.

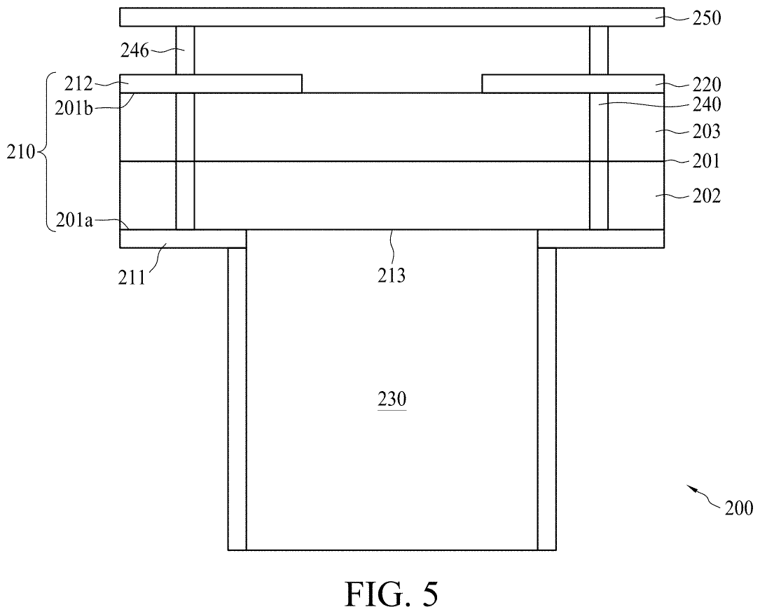

Although the dielectric substrate 101 may be depicted as a single-layer dielectric substrate, as shown in FIG. 3, in some embodiments according to the particular application, the dielectric substrate 101 may also be a multilayer dielectric substrate. FIG. 5 is a cross-sectional view of an apparatus 200 for waveguide transition according to some embodiments of the present disclosure. It should be noted that FIG. 5 is taken along the direction of line A-A′ of FIG. 2. The apparatus 200 is similar to the apparatus 100 for waveguide transition with the exception that the apparatus 200 has a multilayer dielectric substrate, With reference to FIG. 5, the apparatus 200 for waveguide transition includes a dielectric substrate 201, a transmission line structure 210, a conductor pattern 220 for shorting a waveguide 230, and a plurality of vias 240, The dielectric substrate 201 of the apparatus 200 is a multilayer dielectric substrate haying a first dielectric layer 202 and a second dielectric layer 203. The transmission line structure 210 includes a ground conductor pattern 211 separated from a strip conductor pattern 212 by the dielectric substrate 201, wherein the ground conductor pattern 211 has a ground aperture portion 213. In some embodiments, the waveguide 230 is electrically coupled to the strip conductor pattern 212. The vias 240 are electrically coupled to the ground conductor pattern 211 and the conductor pattern 220 for shorting the waveguide 130. In some embodiments, the waveguide 230 is connected to the dielectric substrate 201 so as to correspond to the ground aperture portion 213. In some embodiments, the ground conductor pattern 211 is disposed on a surface 201a of the dielectric substrate 201, and the strip conductor pattern 212 is disposed on another surface 201b of the dielectric. substrate 201 opposite to the surface 201a having the ground conductor pattern 211. In some embodiments, according to the particular application, an adhesive layer and/or a metal layer (not shown) may also be disposed between the first dielectric layer 202 and a second dielectric layer 203 of the dielectric substrate 201.

In some embodiments, the ground aperture portion 213 has a polygonal shape such as a rectangle similar to the ground aperture portion 113 depicted in FIG. 4, for example. A portion of the strip conductor pattern 212 may be configured to be substantially parallel to one side of the polygonal shape. It should be noted that, in some embodiments according to the particular application, the ground aperture portion 213 may be configured as another polygonal shape such as a square, a trapezoid, or other suitable shape having symmetrical or asymmetrical sides. In some embodiments, the polygonal shape of the ground aperture portion 213 may have one side less than twice the length of another side.

In some embodiments, the transmission line structure 210 may further include the first transmission line-splitting portion 10 and the second transmission line-splitting portion 20 depicted in FIG. 1 and FIG. 2. The first transmission line-splitting portion 10 and the second transmission line-splitting portion 20 may be configured such that the apparatus 200 for waveguide transition can be used as a power splitter or a power combiner, for example. In some embodiments, the transmission line structure 210 may further include one or more quarter-wavelength matching sections 30 to optimize the impedance matching of a center frequency of the waveguide 230, which may be 24 GHz, 28 GHz, or 60 GHz, for example.

In some embodiments, as shown in FIG. 5, the apparatus 200 for waveguide transition further includes a metal member 250 disposed above the ground aperture portion 213. The metal member 250 may serve as a backshort layer configured and spaced to optimize the impedance matching for the center frequency of the waveguide 230. In some embodiments, the vias 240 form a plurality of fence via structures 246 which may be configured to further optimize the transition of the waveguide 230, In some embodiments, the fence via structures 246 may be configured to have a polygonal shape with one side greater than twice the length of another side. In some embodiments, according to the particular application, the transmission line structure 210 may be a microstrip line, a stripline, or a coplanar waveguide. In some embodiments, the configurations, spacing, and dimensions of the dielectric substrate 201, the conductor pattern 220, the vias 240, the ground conductor pattern 211, and the strip conductor pattern 212 may also be adjusted according to the center frequency of the waveguide 230.

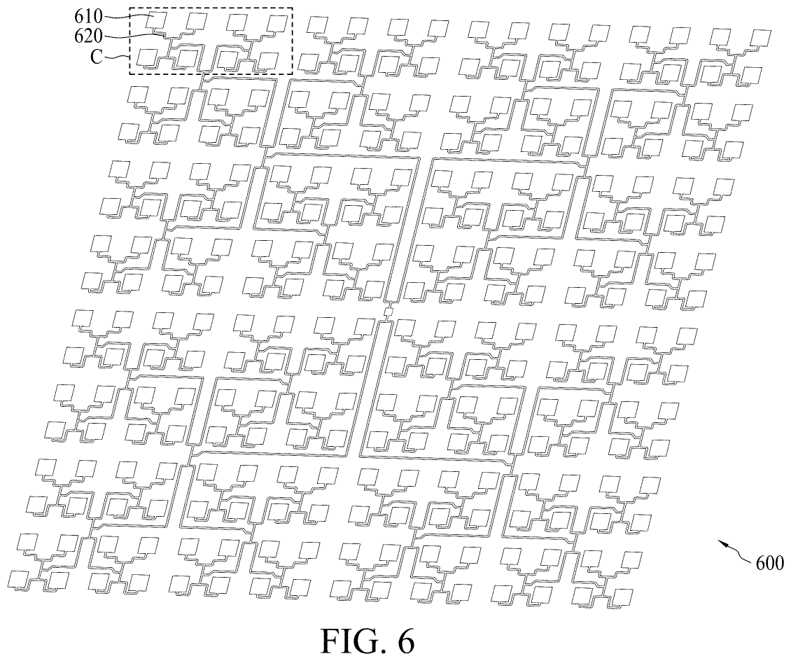

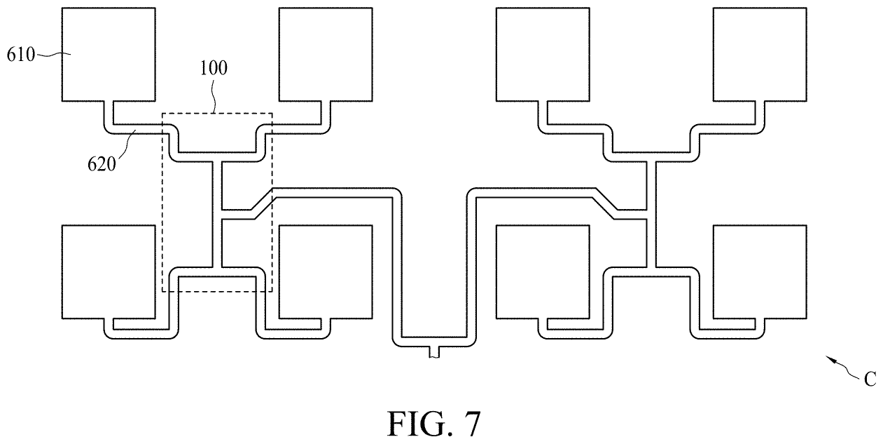

In some embodiments, the apparatus 100 for waveguide transition and the apparatus 200 for waveguide transition may be utilized in an antenna array. FIG. 6 is a perspective view of an antenna array 600 according to some embodiments of the present disclosure, and FIG. 7 is a close-up top view of a section C of the antenna array 600 shown in FIG. 6. With reference to FIG. 6 and FIG. 7, the antenna array 600 includes a plurality of antenna elements 610 spaced apart from each other, and a feed network 620 electrically coupled to the antenna elements 610 for signal distribution. In some embodiments, the feed network may include a plurality of apparatuses 100 for waveguide transition arranged to distribute a signal to the antenna elements 610, as shown in FIG. 6 and FIG. 7. It should be noted that, although FIG. 6 and FIG. 7 depict the apparatuses 100 for waveguide transition being used in the antenna array 600, the apparatuses 200 for waveguide transition may also be used, or a suitable combination of the apparatuses 100 and apparatuses 200 may be used according to the particular application.

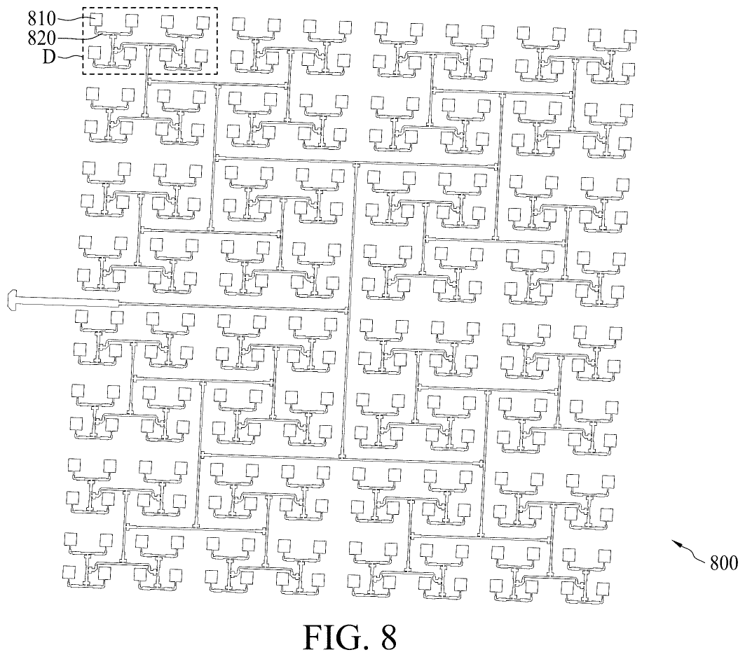

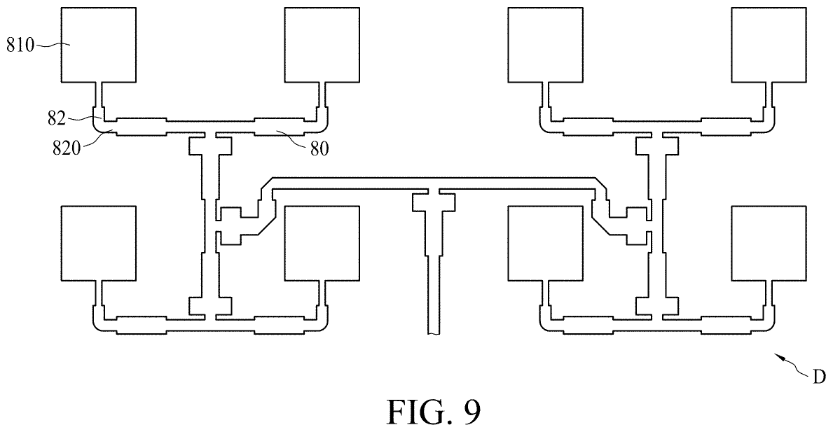

FIG. 8 is a perspective view of an antenna array 800 according to a comparative embodiment of the present disclosure, and FIG. 9 is a close-up top view of a section D of the antenna array 800 shown in FIG. 8. With reference to FIG. 6 to FIG. 9, comparing the antenna array 600 of the present disclosure with the comparative antenna array 800, a feed network 820 of the comparative antenna array 800 requires many more stages of the impedance-matching sections 80 and 82 for signal distribution to the antenna elements 810, while the feed network 620 of the antenna array 600 requires significantly less area. In some embodiments, the apparatuses 100 for waveguide transition, the apparatuses 200 for waveguide transition and the antenna array 600 may be fabricated by standard low-temperature cofired ceramic (LTCC) multilayer techniques as well as other suitable fabrication processes according to the particular application.

Accordingly, the apparatuses 100 for waveguide transition and the apparatuses 200 for waveguide transition of the present disclosure enable impedance matching and power distribution in a compact footprint. Compared to the feed network 820 of the comparative antenna array 800, the apparatuses 100 for waveguide transition in the feed network 620 of the antenna array 600 include impedance-matching and power-dividing or power-combining functions within a compact area without sacrificing performance or complicating fabrication. Therefore, the apparatuses 100 for waveguide transition and the apparatuses 200 for waveguide transition can be readily miniaturized and integrated with other electronic systems.

One aspect of the present disclosure provides an apparatus for waveguide transition, including a dielectric substrate, a transmission line structure, a conductor pattern for shorting a waveguide, and a plurality of vias. The transmission line structure includes a ground conductor pattern separated from a strip conductor pattern by the dielectric substrate, wherein the ground conductor pattern has a ground aperture portion. The waveguide is electrically coupled to the strip conductor pattern. The vias are electrically coupled to the ground conductor pattern and the conductor pattern for shorting the waveguide. The waveguide is connected to the dielectric substrate so as to correspond to the ground aperture portion.

Another aspect of the present disclosure provides an antenna array, including a plurality of antenna elements spaced apart from each other, and a feed network electrically coupled to the antenna elements for signal distribution. The feed network includes a plurality of apparatuses for waveguide transition. At least one the apparatuses for waveguide transition includes a dielectric substrate, a transmission line structure, a conductor pattern for shorting a waveguide, and a plurality of vias. The transmission line structure includes a wound conductor pattern separated from a strip conductor pattern by the dielectric substrate, wherein the ground conductor pattern has a ground aperture portion. The waveguide is electrically coupled to the strip conductor pattern. The vias are electrically coupled to the ground conductor pattern and the conductor pattern for shorting the waveguide. The waveguide is connected to the dielectric substrate so as to correspond to the ground aperture portion.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps. described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture compositions of matter, means, methods, an steps.

What is claimed is:

1. An apparatus for waveguide transition comprising:
a dielectric substrate:
a transmission line structure comprising a ground conductor pattern separated from a strip conductor pattern by the dielectric substrate, the ground conductor pattern having a ground aperture portion;
a conductor pattern for shorting a waveguide, wherein the waveguide is electrically coupled to the strip conductor pattern; and
a plurality of vias electrically coupled to the ground conductor pattern and the conductor pattern for shorting the waveguide,
wherein the waveguide is connected to the dielectric substrate so as to correspond to the ground aperture portion.

2. The apparatus of claim I, wherein the transmission line structure further comprises a first transmission line-splitting portion and a second transmission line-splitting portion.

3. The apparatus of claim 1, wherein the ground conductor pattern is disposed on a surface of the dielectric substrate, and the strip conductor pattern is disposed on another surface of the dielectric substrate opposite to the surface having the ground conductor pattern.

4. The apparatus of claim 1, wherein the transmission line structure further comprises one or more quarter-wavelength matching sections.

5. The apparatus of claim 1, wherein the ground aperture portion has a polygonal shape, and a portion of the strip conductor pattern is substantially parallel to one side of the polygonal shape.

6. The apparatus of claim 1, wherein the dielectric substrate is a single-layer dielectric substrate.

7. The apparatus of claim 1, wherein the dielectric substrate is a multilayer dielectric substrate.

8. The apparatus of claim 1, further comprising a metal member disposed above the ground aperture portion.

9. The apparatus of claim 1, wherein the vias form a plurality of fence via structures.

10. The apparatus of claim 1, wherein the transmission line structure is a microstrip line, a stripline, or a coplanar waveguide.

11. An antenna array comprising:
a plurality of antenna elements spaced apart from each other; and
a feed network electrically coupled to the antenna elements for signal distribution, wherein the feed network comprises a plurality of apparatuses for waveguide transition, at least one the apparatuses for waveguide transition comprising:
a dielectric substrate;
a transmission line structure comprising a ground conductor pattern separated from a strip conductor pattern by the dielectric substrate, the ground conductor pattern having a ground aperture portion;
a conductor pattern for shorting a waveguide, wherein the waveguide is electrically coupled to the strip conductor pattern; and
a plurality of vias electrically coupled to the ground conductor pattern and the conductor pattern for shorting the waveguide,
wherein the waveguide is connected to the dielectric substrate so as to correspond to the ground aperture portion.

12. The antenna array of claim 11, wherein the transmission line structure further comprises a first transmission line-splitting portion and a second transmission line-splitting portion.

13. The antenna array of claim 11, wherein the ground conductor pattern is disposed on a surface of the dielectric substrate, and the strip conductor pattern is disposed on another surface of the dielectric substrate opposite to the surface having the ground conductor pattern.

14. The antenna array of claim 11, wherein the transmission line structure further comprises one or more quarter wavelength matching sections.

15. The antenna array of claim 11, wherein the ground aperture portion has a polygonal shape, and a portion of the strip conductor pattern is substantially parallel to one side of the polygonal shape.

16. The antenna array of claim 11, wherein the dielectric substrate is a single-layer dielectric substrate.

17. The antenna array of claim 11, wherein the dielectric substrate is a multilayer dielectric substrate.

18. The antenna array of claim 11, wherein at least one of the apparatuses for waveguide transition further comprises a metal member disposed above the ground aperture portion.

19. The antenna array of claim 11, wherein the vias form a plurality of fence via structures.

20. The antenna array of claim 11, wherein the transmission line structure is a microstrip line, a stripline, or a coplanar waveguide.
